(19) United States
(12) Patent Application Publication
(10) Pub. No.: US 2025/0222906 A1
(43) Pub. Date: Jul. 10, 2025

(54) WHEEL CLAMPS

(71) Applicant: AFFIN AS, Oslo (NO)

(72) Inventors: Christopher John KAVANAGH, Oslo (NO); Eivind BRYNE, Sandvika (NO); Harald FURU, Oslo (NO); Emil ABRY, Hosle (NO); Christian ABRY, Eiksmarka (NO)

(21) Appl. No.: 18/861,639

(22) PCT Filed: Apr. 17, 2023
(86) PCT No.: PCT/NO2023/050086

§ 371 Date: Oct. 30, 2024

(30) Foreign Application Priority Data
Apr. 19, 2022 (NO) 20220449

(51) Int. Cl. B60T 3/00; B60R 25/09

(52) U.S. Cl. CPC B60T 3/00; B60R 25/09

(57) ABSTRACT

This present invention relates to a wheel clamp adapted to being mounted on tyres of the vehicle wheels to prevent removal of the vehicle. The device includes a central housing (2) from which protrudes radially multiple arms (3) which are extended at the outer end by anti-slip components (10) transversally embracing the tread of a tyre. The wheel clamp has a first locking mechanism that consists of a locking element (24) with teeth engaging with teeth on the inner circumference of the housing (2). The wheel clamp has second locking means (30) that interfaces with a handle (16) when the device is mounted onto the wheel.

### TECHNICAL FIELD

This invention relates generally to a wheel lock for immobilizing vehicles.

### DESCRIPTION AND DRAWBACKS OF PRIOR ART

In many jurisdictions police or other public agencies use wheel clamps to immobilize vehicles that are illegally parked. In addition, private car owners may want to use the same principle to avoid thefts, for example when leaving the car for extended periods.

DE 20 2004 004 887 discloses a wheel clamp similar to the present invention. In general, it is too simple and it would seem easy to break open the arms or force open the lock. It is therefore an object of the present invention to overcome these disadvantages of the prior art and to present to the market a wheel clamp that is simple, adjustable, effective and efficient, modular and thus compact, lightweight and rational for manufacturing.

FR 2620672 discloses a device for preventing the rotation of a vehicle wheel. This shows a housing with arms held within the housing and protruding radially therefrom and equipped with removably attachable grip elements to be arranged on the tread surface of a tyre. It further shows operating means equipped with locking means capable of preventing the extension of the arms when engaged, a hub rotatable within the housing operated by using a handle and a crank.

### SUMMARY OF INVENTION

The primary object of this invention is to provide a wheel clamp which is easy to mount and dismount from the wheel without the need of skills, physical strength or a separate tool.

Another object of the invention is to provide a wheel clamp which is simple, compact and made of few parts.

Another object of this invention is to provide a wheel clamp which can be mounted from the front face of the wheel and can be adapted to different wheel sizes.

Yet another object of the invention is to add a wheel clamping function to the anti skid device described in No. 20191262 by replacing one or more of the anti skid friction pads attached to the extremities of the arms with elements whose aim is to both prevent the removal of the device from the wheel and prevent the wheel from rotating.

These and other objectives are achieved by providing the device with locking elements that keeps the device fastened to the wheel during use.

### BRIEF DESCRIPTION OF DRAWINGS

FIG. 1 is a front view of the wheel clamp device,

FIG. 2 is an exploded view of the device with the wheel grips removed.

FIG. 3 is a front view of the device with the handle opened.

FIG. 4 is a vertical section of the hub with the handle opened.

FIG. 5 shows the hub component with the handle partially opened,

FIG. 6 is cross section view of the hub component with the handle closed and lock engaged,

FIG. 7 shows an underside view of hub component with the handle closed and lock engaged,

FIG. 8 shows an underside view of hub component with the handle closed and lock disengaged,

FIG. 9 is a detail view of a grip element.

FIG. 10 is a detail view of a second embodiment of a grip element.

FIG. 11 is a detail view of a third embodiment of a grip element.

FIG. 12 is a detail view of a fourth embodiment of a grip element.

FIG. 13 is a detail view of a fifth embodiment of a grip element.

FIG. 14 shows a front view of a second embodiment of the hub component with the handle closed and lock engaged.

FIG. 15 shows a front view of a second embodiment of the hub component with the handle closed and lock disengaged.

### DESCRIPTION OF EMBODIMENTS

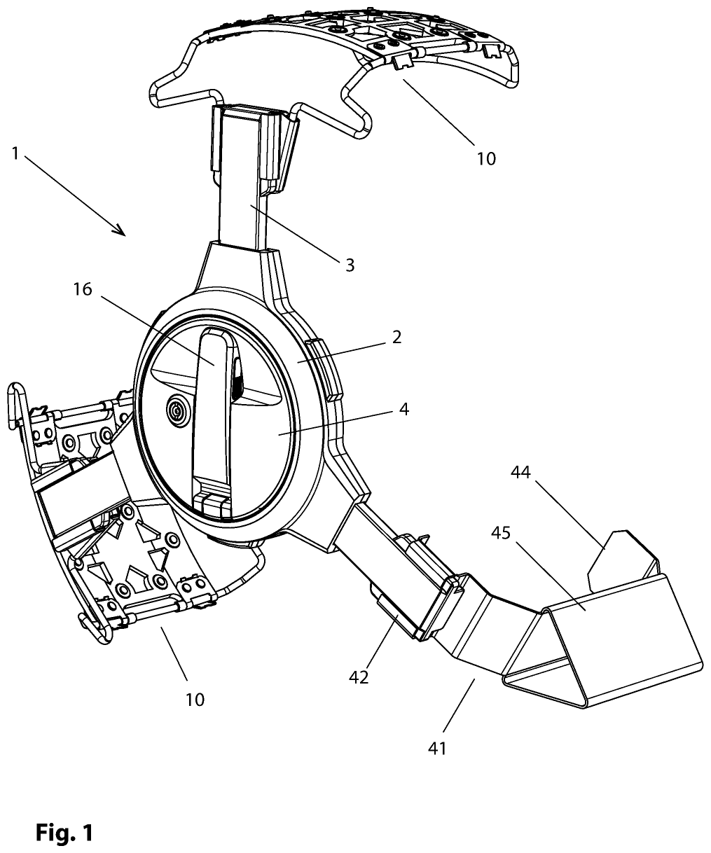

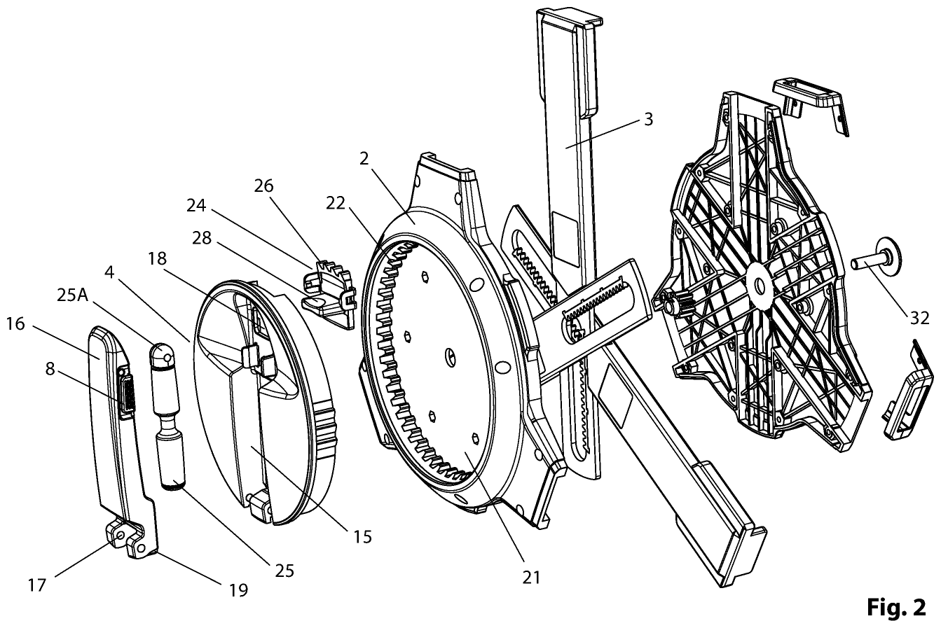

Referring to FIG. 1 there is shown a wheel clamp 1 according to the invention. The device 1 consists of a housing 2 and three arms 3. Although three arms are shown in the drawings it should be understood that there may be four or more arms. The housing encloses the inner ends the arms 3 and the mechanism for operating the arms. A hub 4 is rotatable in the housing 2. The hub has a shaft 32 (see FIG. 2) that is connected to a pinion that in turn enables the arms to move outwards resp. inwards. These details are more fully described in our previous application No. 20191262 and will not be further discussed here since they do not form a part of the present invention.

At the outer ends of arms 3 are attached grip elements 10, 41 arranged to span the width of a tyre and extend partially behind the rear surface of the tyre.

At least one of the grip elements 10,41 is equipped with a protrusion 45 to prevent the rotation of a tyre. (See FIGS. 1, 9-13).

Referring now to FIG. 2 the hub has a recess 15. A handle 16 has at one end a hinge 17 enabling the handle to be folded into the recess 15. There is also an opening 18 through the hub. At the other (distal) end of the handle there are means that interfaces with a locking mechanism. This will be described in more detail later.

The handle is folded into the recess when in its locked position. It is also folded when not in use, for example during transport. The handle may include a release element 8 with a catch that can be operated in order to swing the handle outwards. This is an additional safety feature to avoid accidental folding out of the handle 16.

A crank 25, located within the handle when not in use, can be swung outwards and is used to rotate the hub 3 and via the axle 32 used to operate the inwards or outwards movement of the arms 3. The crank 25 is hinged to the handle 16 on a pivoting base 25A that interface with the locking mechanism as described further below. It will be apparent that the device should be fitted to a wheel when the arms 3 are extended. The crank 25 is then used to retract the arms 3 such that elements 10, 41 tightly grip the tyre, prior to locking the device in this position to prevent the vehicle being driven or the removal of the device.

The housing 2 has a circular recess 21 accommodating the hub 4. The housing 2 has an inner diameter that is slightly larger than the outer diameter of the hub 4 enabling the hub 4 to rotate in the housing 2 on the axle 32. The inner circumference of the housing 2 is equipped with multiple protrusions or teeth 22.

A locking element 24 is held below and protrudes through the recess 18 in the hub 4. Locking element 24 is equipped with a number of protrusions or teeth 26 along a peripheral edge that can interface with corresponding teeth 22 in the housing 2. On the side facing towards the user a rib 28 protrudes outwards and divides the facing side into upper and lower areas. Whilst locking element 24 is positioned between hub 4 and housing 2, the rib 28 penetrates window 18 and is thus accessible to the user. Rib 28 thus acts as a sliding lever that allows the user to manually move the locking element 24 into or out of contact with the ring teeth 22.

In addition, the geometry of the interacting components is such that the handle 16 and crank 25 may not be properly closed when the locking element 24 is in the Open position, as the pivoting base 25A of the crank will crash with rib 28 of the locking element 24 when in the Open position. More clearly, the locking element 24 must be locked in order to be able to close the device such that it is ready for use—an additional safety feature.

When handle 16 is opened outwards the locking element 24 is free to move.

In a preferred embodiment the two areas of locking element 24 visible on either side or rib 28 are colour coded so that the operator may determine the state of the locking element. For example, green for the side closest the centre of the hub and red for the side away from the centre. When the locking element 24 is in either the locked or open positions, only one of these colours will visible, thus clearly indicating the status of the device.

FIG. 3 shows a front view of the device in the operating position. The handle 16 has been folded out from the recess 15. The crank 25 is at its end 25A hinged to the handle and when swung out, as shown in FIG. 3 is used to turn the hub which in turn operates the extension and the retraction of the arms 3. FIG. 3 shows the locking element 24 engaged with the teeth 22 in the housing with the rib 28 protruding through the window 18, i.e., in locked position. Prior to operation of the handle the locking element 24 is disengaged, thus enabling the hub to be turned.

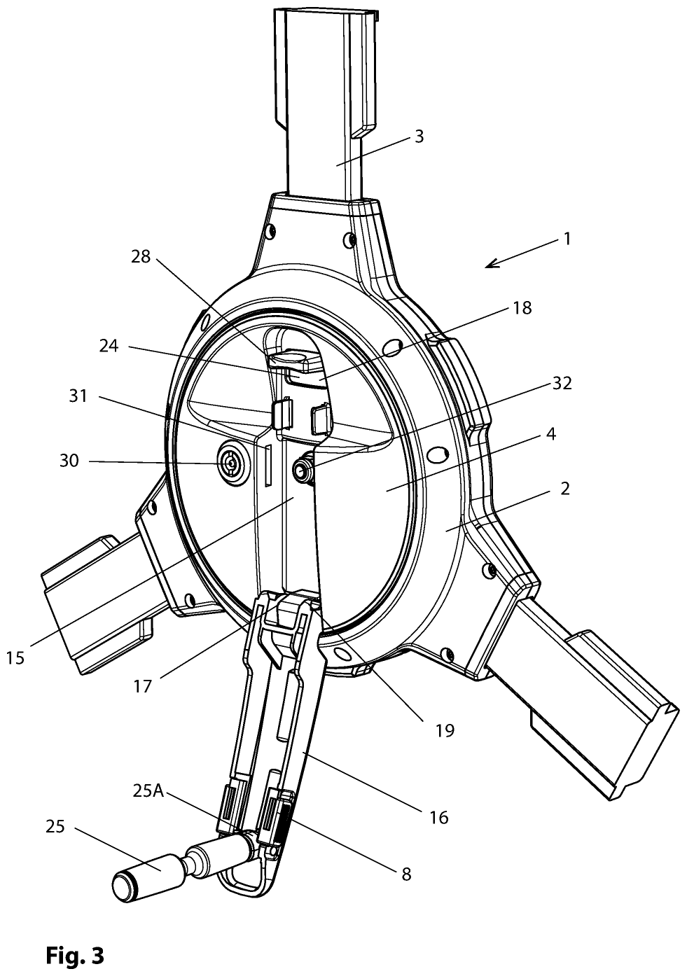

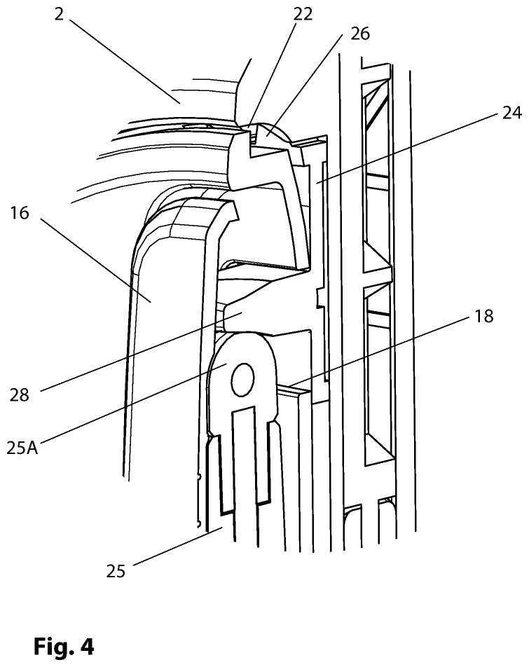

FIG. 4 is a detail showing the method of holding the locking element 24 in a secured position. The rib 28 that protrudes through the window 18 interfaces with end 25A of crank 25. Crank 25 is pushed so that its end 25A is under the rib 28. Then when handle 16 is closed the locking element is held in contact with teeth 22, i.e., its locking position, Buttons 8 secure the handle 16 to the hub 4 so that the handle 16 may not open accidentally while driving.

In addition to the teeth on the Lock, 2 additional teeth 19 are integrated with the lower pivoting end of the handle 16 close to hinge 17. When the handle 16 is moved to the closed position, the teeth will form an additional mechanical lock with the teeth 22 in the housing.

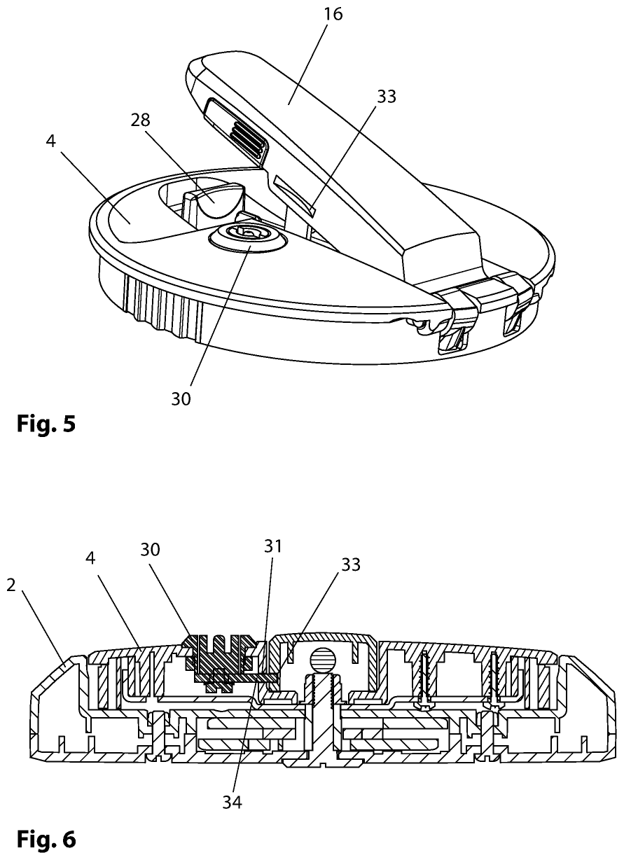

FIG. 5 shows a perspective view of the hub 4 with an additional lock mechanism used to secure the device so that the wheel clamp cannot be removed from the wheel without the use of a key. In this view the housing 2 and other details are removed for better clarity. The handle 16 is shown partially opened, and has on one of its sides a slot 33. Slot 33 may penetrate handle 16 partially or completely. In the hub 4 there is a lock 30 that is operated by a key (not shown). This lock and key can be any type that is suitable. For example, police would prefer to use an especially secure key while for a private person a simpler key might be sufficient to avert theft.

FIG. 6 shows a cut-away view of the hub 4 above. As can be seen in the figure the lock 30 is arranged in the hub 4 and includes a mechanism that, when the key is rotated in the lock 30, causes a tongue 34 to be rotated through an opening 31 in the side of recess 15 into the slot 33 in the handle 16.

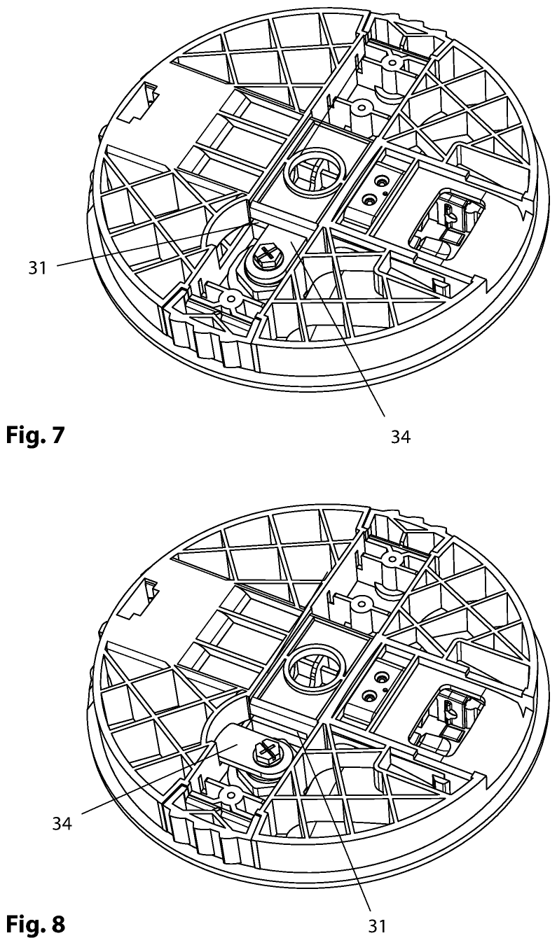

FIGS. 7 and 8 show a view of the rear side of the hub 4. FIG. 7 shows the mechanism in the locked position and FIG. 8 in the open or unlocked position. Here the rotation of tongue 34 may be more clearly seen.

The operation of the device is as follows: The device is stored in a safe place for example the boot of a car. When it is needed the device will be placed beside the wheel and the handle 16 & crank 25 swung open. Then the crank 25 is used to first turn the hub 4 anti clockwise to extend the arms 3 outwards such that the device 1 can be mounted onto the wheel, with grip and immobilizing elements 10, 41 encompassing the wheel. When in place around the tire the crank 25 will be turned in the clockwise direction to retract the arms 3 until the grip elements 41 fit tightly around the rim of the wheel. When the operator is satisfied that the grip elements 41 have fully engaged around the tyre he or she will move the locking element 24 into engagement with the teeth 22. The locked status may be verified by observing the face of the locking element showing green. Then the user moves the crank 25 back into the handle 16 and handle 16 folds back into the recess 15. This fixes the length of the arms and holds the wheel clamp 1 in place. The operator will then use the designated key to turn the lock 30 so that the tongue 34 will engage the slot 33. Thereupon the key is removed and the wheel clamp is securely fastened to the vehicle.

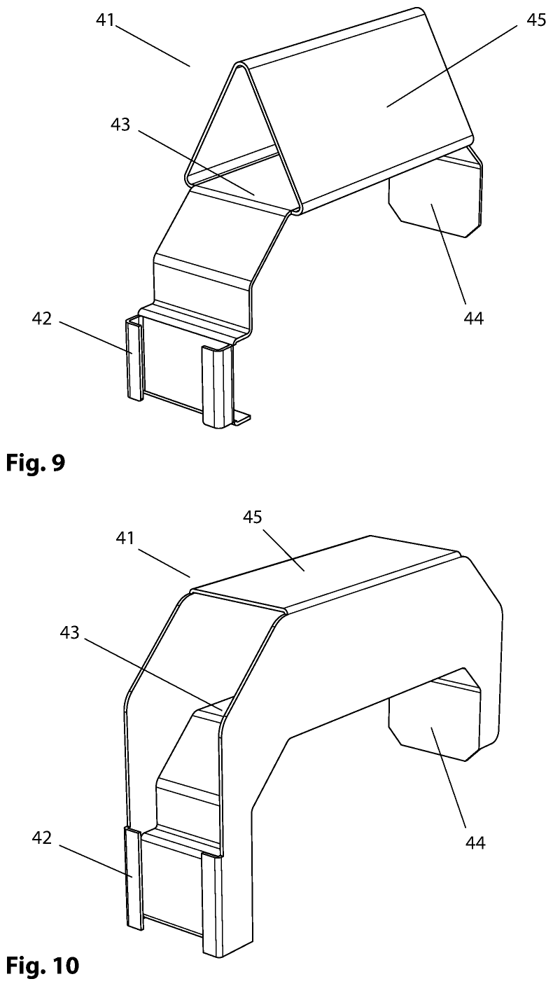

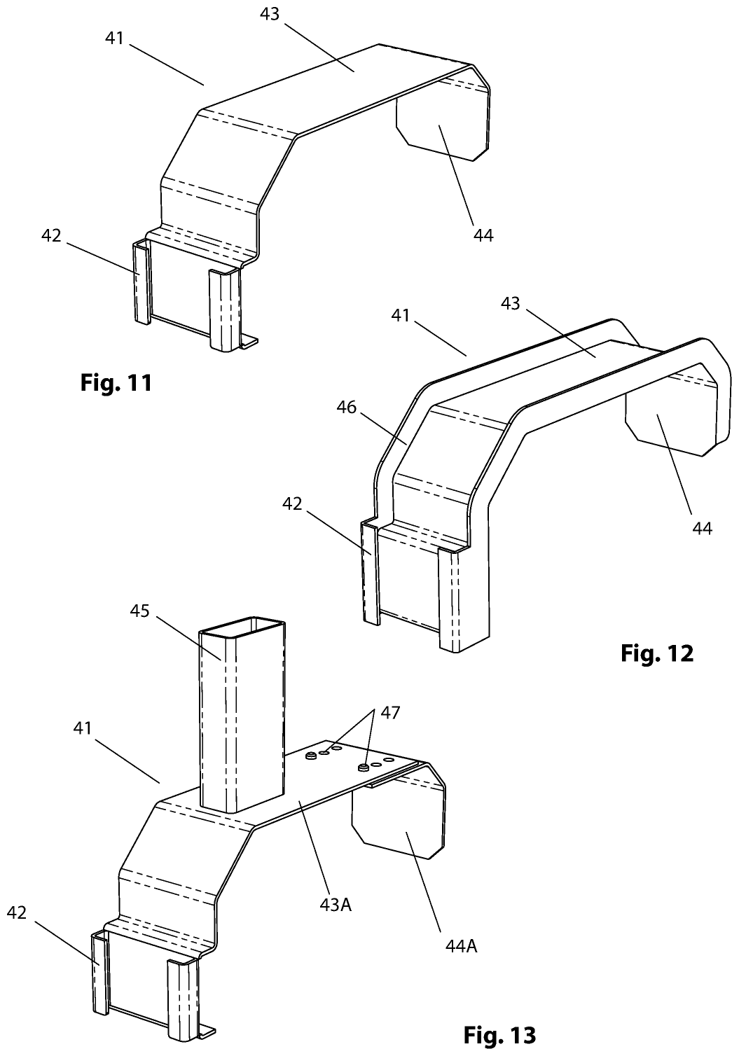

In FIG. 9 there is shown a first embodiment of the grip element 41. Element 41 is arranged such that it spans the width of the tyre, with a portion extending downwards to grip around the inner sidewall of the tyre. The immobilizing element 41 is largely U shaped to grip securely around the tyre. The U-shaped bracket 41A has a front side 42 that attaches to the arm 3, a side arranged to span the tyre 43 and a rear side 44 that fits around the back of the tyre. The means by which grip element 41 attaches to arm 3 allows the grip elements 41 to be detached for compact storage, however it should be noted that it is not possible to detach the grip elements 41 when they are fastened around a tyre. Rear side 44 should be of sufficient length that it is not possible to rotate the device 1 off the tyre when fastened around the tyre. However, the length should not be substantially longer than necessary as this both makes mounting the device difficult and requires that the arms 3 can extend further to encompass the tyre. From experimentation it has been found that a length of between 30 and 100 mm works well, even more preferably between 40 to 60 mm. The device may be equipped with one or multiple grip elements 41 as described above, also shown in FIG. 11. In addition, the device 1 should be equipped with at least one grip element 41 where from side 43 a protrusion 45 is arranged, said protrusion 45 intended to prevent the rotation of the wheel. The protrusion 45 should be of such height that it interferes with the wheel's rotation by striking the undercarriage/body of the vehicle, such that the wheel may not rotate further. The distance between tyre and body varies greatly from vehicle to vehicle, but it has been found that a protrusion height of between 40-300 mm from the bracket provides a sufficient obstacle to the rotation of the tyre. Even more preferably the length of the protrusion should be between 100-150 mm. In the embodiment shown here the protrusion is in the shape of a triangle and is integrated with the side 43 for ease of production.

FIG. 10 shows an alternate embodiment of the grip element 41 where the protrusion 45 is arranged in the form of a box section, which has the added advantage of providing extra stiffness to the construction of element 41.

FIG. 11 shows a detail view of a preferred embodiment of grip element 41. Grip 41 is not intended to prevent the wheel from turning, instead its purpose is to hold the device 1 firmly to the wheel, such that the device 1 may not be removed from the wheel without the use of the matching key for lock 30. Here the attaching details 42 that connect grip 41 to the end of arm 3 may be seen, together with the return detail 44. The grip element 41 would preferably be manufactured in a metal material to be sufficiently stiff and strong enough to resist a thief's attempts to remove the device 1 from the wheel. It is also possible that the material used could be a thermoplastic material of sufficient strength and stiffness, for example acetal or a glass reinforced nylon material. It is also possible that the element 41 be produced in a composite material of sufficient stiffness, for example carbon fiber.

FIG. 12 shows a second embodiment of the grip element 41 shown in FIG. 11, however in this case it is strengthened along the edges with a flange 46 to allow for production in a thinner sheet metal/plastic/composite material without a corresponding reduction in the stiffness of the element 41. In addition, it is possible to increase the length of flange 46 such that it in itself provides a sufficient thickness or protrusion from the tyre so as it prevents the tyre's rotation. In this case a thickness of 40 mm or more may prove sufficient, depending upon the diameter of the target tyre.

FIG. 13 shows another embodiment of the grip element 41. In this embodiment, element 41 is comprised of several elements 43A and 44A that are slidably engaged with each other and allow the user to adjust the width of the element where it surrounds the tyre so that it fits the width of the tyre as snugly as possible. The user adjusts the width prior to assembling the device to the tyre, using screws 47 or another fixation system whereby these are adjusted from the underside of 43A and thus inaccessible when the element 41 is mounted to the tyre. It will be apparent that with the grip elements 41 adapted to fit as tightly as possible in both axial and radial directions around the tyre that the chance of a thief being able to bend or rotate the device off the tyre becomes even more remote. A protrusion 45 is also shown protruding from the outer surface of 43, in this case in the form of a tube.

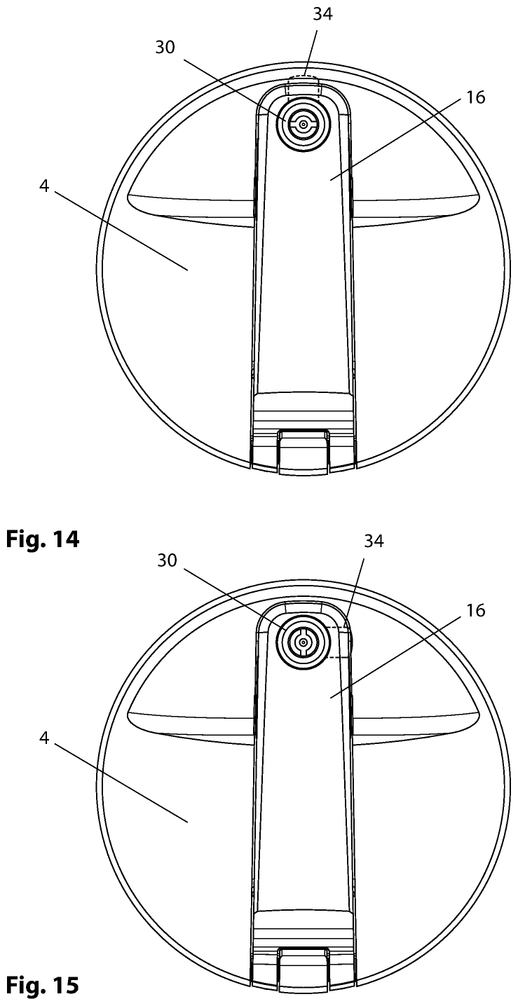

FIG. 14 shows a front view of hub 4 and handle 16 of an alternate embodiment of the device 1. In this embodiment, lock 30 is situated on handle 16 and positioned so that tongue 34 may rotate in and out of engagement with a slot 31 positioned to receive tongue 34 when in the engaged or locked position. Whilst the lock 30 described in the above embodiments features a rotatory action, it should be understood that the same function may be achieved with a lock that allows a linear sliding of tongue 34 between 2 set positions, engaged or disengaged to prevent the opening of handle 16 from hub 4.

Grip elements 10 and 41 could also be formed in other ways to perform the same task without deviating from the spirit of the invention. For example, protrusion 45 may extend in a different direction from that shown in the Figures, so long as the protrusion 45 hinders the movement of the wheel.

It is also possible to arrange the secondary locking means such that the movement of tongue 34 is mechanically linked to a second tongue that interfaces a second slot in handle 16 from the opposite side, thus 2 tongues are rotatably engaged by a single lock and key and the handle 16 would be held even more securely.

The key used to engage or disengage lock 30 may be a standard key, a key composing a special form that matches a form positioned on the lock, a magnetic key or other types of key without deviating from the spirit of the invention.

1-7. (canceled)

8. A device for preventing the rotation of a vehicle wheel, comprising:
a housing;
a plurality of at least three arms held within the housing and protruding radially therefrom;
said arms equipped with removably attachable grip elements to be arranged on the tread surface of a tire;
the grip elements equipped with means for engagement with the ground to prevent removal of the vehicle;
operating means to allow the extension or contraction of said arms;
said operating means equipped with locking means capable of preventing the extension of the arms when engaged;
a hub rotatable within the housing;
said hub operated by using a handle and a crank;
where the handle can be folded into a recess in the hub; and
the device is equipped with further locking means arranged to prevent the removal of handle from the recess.

9. The device according to claim 8, wherein the locking means that can be engaged and disengaged using a key.

10. The device according to claim 8, wherein the turning of the key that moves a tongue that engages a slot in the handle.

11. The device according to claim 8, wherein the grip elements that are equipped with an extension arranged to extend behind the inside wall of a tyre, said extension being in the range of 30 to 100 mm from a surface of the grip element.

12. The device according to claim 8, wherein the ground engaging means that is equipped with a protrusion to prevent removal of the vehicle.

13. The device according to claim 12, wherein the protrusion that is in the range of 40 to 300 mm in length.

14. The device according to claim 8, wherein the grip element which is divided into two elements, said elements slidably engaged to allow the width of grip element to be adjusted.
